(19) United States
(12) Patent Application Publication
(10) Pub. No.: US 2022/0300990 A1
(43) Pub. Date: Sep. 22, 2022

(54) INFORMATION PROCESSING DEVICE, INFORMATION PROCESSING METHOD, AND NON-TRANSITORY COMPUTER READABLE STORAGE MEDIUM

(71) Applicant: Yahoo Japan Corporation, Tokyo (JP)

(72) Inventors: Kota TSUBOUCHI, Tokyo (JP); Hidehito GOMI, Tokyo (JP); Teruhiko TERAOKA, Tokyo (JP)

(21) Appl. No.: 17/688,521

(22) Filed: Mar. 7, 2022

(30) Foreign Application Priority Data
Mar. 18, 2021 (JP) 2021-045241

(51) Int. Cl. G06Q 30/02

(52) U.S. Cl. CPC G06Q 30/0201

(57) ABSTRACT

An information processing device according to the present application includes an extraction unit, a generation unit, and a provision unit. The extraction unit extracts, from action history information of the user, feature information for specifying an action of the user. The generation unit generates action trajectory data expressing a compressed action trajectory of the user within a predetermined period in a time axis direction by using the feature information extracted by the extraction unit. The provision unit provides the user with the action trajectory data generated by the generation unit.

### CROSS-REFERENCE TO RELATED APPLICATIONS

The present application claims priority to and incorporates by reference the entire contents of Japanese Patent Application No. 2021-045241 filed in Japan on Mar. 18, 2021.

### BACKGROUND OF THE INVENTION

### 1. Field of the Invention

The present application relates to an information processing device, an information processing method, and an information processing program.

### 2. Description of the Related Art

Conventionally, a technique has been proposed in which digital data of various activity records of an individual is recorded as a life log (action history), and the recorded life log is aggregated and presented to a user. For example, there is known a related art in which, in a case where there is a photographed image in association with a date of a calendar displayed on a monthly list display screen, a recognition image indicating that there is an image is displayed, and in a case where a recognition image of any date is selected, an image of the selected date is displayed in a list (for example, Patent Document 1).

However, the life log has a large data amount, and the burden on the user required for confirmation may be large.

### SUMMARY OF THE INVENTION

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to an embodiment;

FIG. 2 is a diagram illustrating an example of a method for generating action trajectory data according to the embodiment;

FIG. 3 is a diagram illustrating a configuration example of an information processing system according to the embodiment;

FIG. 4 is a diagram illustrating a configuration example of an information processing device according to the embodiment;

FIG. 5 is a diagram illustrating an example of action history information according to the embodiment;

FIG. 6 is a diagram illustrating an example of user information according to the embodiment;

FIG. 7 is a flowchart illustrating an example of a processing procedure by the information processing device according to the embodiment; and

FIG. 8 is a hardware configuration diagram illustrating an example of a computer that realizes functions of the information processing device according to the embodiment and the modifications.

### DETAILED DESCRIPTION OF THE PREFERRED EMBODIMENTS

Hereinafter, modes (hereinafter referred to as “embodiment”) for implementing an information processing device, an information processing method, and an information processing program according to the present application will be described in detail with reference to the drawings. Note that the information processing device, the information processing method, and the information processing program according to the present application are not limited by the embodiments described below. In addition, the embodiments described below can be appropriately combined within a range that does not contradict processing contents. In addition, in the embodiment described below, the same parts are denoted by the same reference numerals, and redundant description will be omitted.

1. Overview of Information Processing

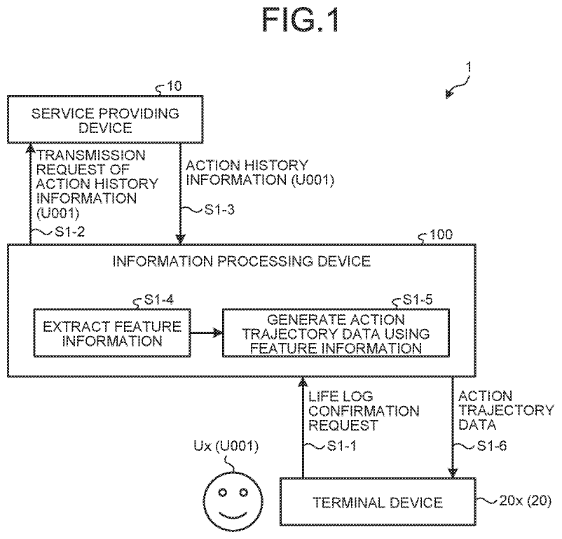

Hereinafter, an example of information processing according to an embodiment will be described with reference to the drawings. FIG. 1 is a diagram illustrating an example of information processing according to an embodiment. Note that an information processing system 1 according to the embodiment may include more service providing devices and terminal devices than the example illustrated in FIG. 1. In addition, in FIG. 1, a user Ux is exemplified as an example of the user of a terminal device 20x, but an information processing device 100 according to the embodiment can execute information processing for an arbitrary number of terminal devices and an arbitrary number of users.

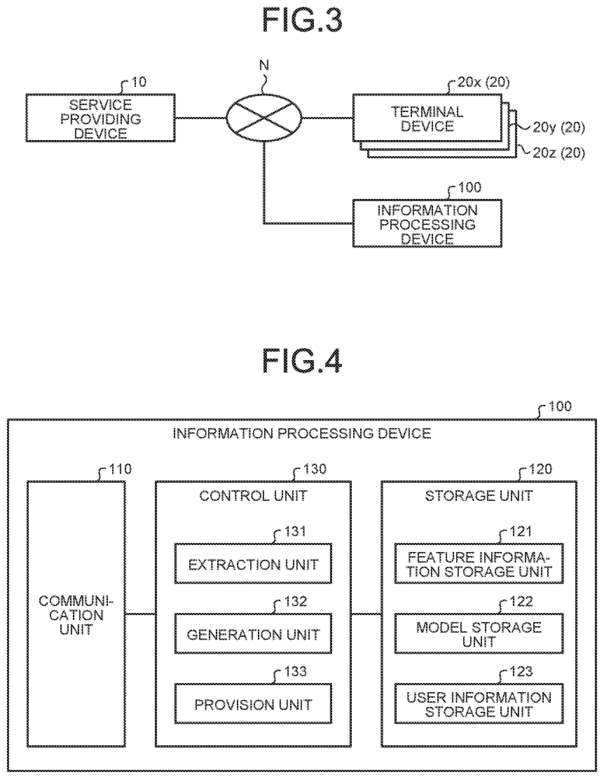

As illustrated in FIG. 1, an information processing system 1 according to the embodiment includes a service providing device 10, the terminal device 20x (20), and the information processing device 100. The service providing device 10, the terminal device 20x, and the information processing device 100 can communicate with each other through a network N (see, for example, FIG. 3) such as the Internet.

The service providing device 10 provides various services to a service user. In addition, the service providing device 10 records action history information (so-called log information) regarding the service user. The action history information recorded by the service providing device 10 includes a history of action associated with the service user with use of various services provided by the service providing device 10, and arbitrary information that can be acquired by the terminal device 20x or a device used by the user Ux such as a wearable device. As specific examples, the action history information includes a log indicating a history of searches or browsing sites performed by the user Ux on the web, a log indicating that a document request for an arbitrary product has been made, a log indicating a history of transmitted contents written on a social network service (SNS) or an Internet bulletin board, or the like.

In addition, the action history information may include a history of a position acquired by the terminal device 20x, a wearable device used by the user Ux or the like using a global positioning system (GPS), a beacon, or the like, healthcare data such as a blood pressure, a heart rate, or the number of steps of the user Ux, a credit card use history of the user Ux, a use history of a bank account of an Internet-only bank owned by the user Ux, a history of a product purchased by the user Ux, or the like. That is, the action history information may include a history of action of the user Ux in the real world, a so-called life log.

In addition, the action history information may include a log related to an operation on the terminal device 20x and a log related to a physical state including a posture such as an inclination or a direction of the terminal device 20x acquired by various sensors included in the terminal device 20x. In addition, the action history information may include a log indicating a use history of functions of the terminal device 20x such as FeliCa (registered trademark), a log indicating a network to which the terminal device 20x has been connected, and a log indicating a communication history with surrounding terminal devices performed by the terminal device 20x via near field communication or the Internet. In addition, the action history information may include a log indicating a history of arbitrary functions of the terminal device 20x, such as the type and contents of web content displayed by the terminal device 20x, that is, log information indicating transition of the state of the terminal device 20x.

Note that the information processing system 1 may include an arbitrary server device that records the action history information regarding the service user, separately from the service providing device 10. In this case, the information processing device 100 acquires, from the arbitrary server device, the action history information corresponding to the provision destination user (for example, the user Ux of the terminal device 20x, or the like) to be the provision destination of the life log.

The terminal device 20x illustrated in FIG. 1 is used by the user Ux who uses various services provided from the service providing device 10. In addition, the terminal device 20x is also used by the user Ux when the user Ux uses the life log provided from the information processing device 100. The terminal device 20x is typically a smartphone, a mobile phone, or the like.

The information processing device 100 executes a processing of providing the life log of the user Ux in response to a request from the user Ux who is a user of the terminal device 20x. The information processing device 100 is typically a server device.

In such the information processing system 1, when receiving the life log confirmation request from the terminal device 20x (step S1-1), the information processing device 100 transmits a transmission request of the action history information regarding the user Ux of the terminal device 20x to the service providing device 10 (step S1-2).

For example, the information processing device 100 can request acquisition of action history information recorded within a predetermined period for the user Ux (ID: U001). In addition, the corresponding period of the action history information requested to be acquired by the service providing device 10 may be set by the user Ux of the terminal device 20x when the life log confirmation request is transmitted, or may be set in advance in the information processing device 100.

In addition, when receiving the action history information of the user Ux from the service providing device 10 (step S1-3), the information processing device 100 extracts feature information for specifying the action of the user Ux from the action history information of the user Ux (step S1-4). For example, the information processing device 100 can extract position information, action information, or the like of the user Ux from the action history information as the feature information described above. The action information can be extracted from basic information such as an activity time and a sleep time of the user Ux, a use history of various services corresponding to the user Ux, or the like.

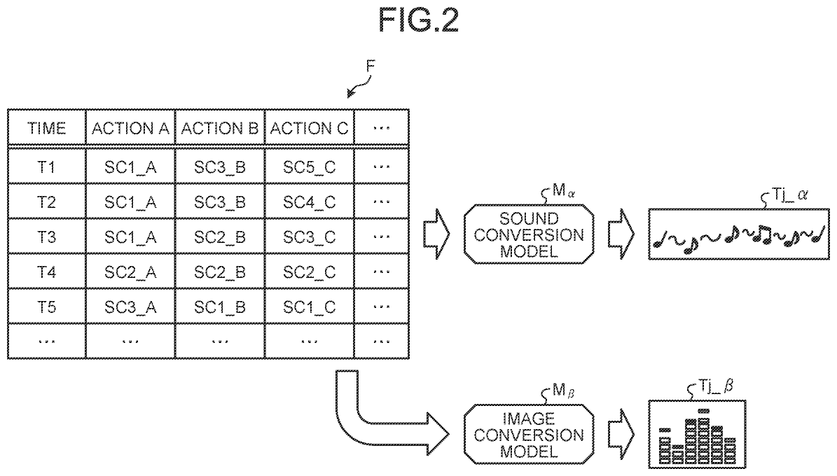

In addition, the information processing device 100 uses the extracted feature information to generate action trajectory data expressing a compressed action trajectory of the user Ux in the time axis direction (step S1-5). For example, the information processing device 100 generates action trajectory data that can be recognized by the user Ux audibly or visually. An example of a method for generating action trajectory data according to the embodiment will be described with reference to FIG. 2. FIG. 2 is a diagram illustrating an example of a method for generating action trajectory data according to the embodiment.

First, the information processing device 100 uses a numerical value associated with the position information, the action information or the like extracted as the feature information from the action history information of the user Ux as a numerical value column (matrix) indicating the action trajectory of the user Ux. For example, the information processing device 100 handles numerical values (scores) associated with each information label such as “action A” to “action C” constituting feature information F illustrated in FIG. 2 as a multi-dimensional numerical value column that characterizes the action trajectory of the user Ux.

Then, the information processing device 100 generates action trajectory data Tj_α in which the action trajectory of the user Ux is expressed (made audible) by a change in sound, for example, using the sound conversion model M_{α}. The sound conversion model M, is a model that converts the feature information F illustrated in FIG. 2 into acoustic information, and can be configured by associating a volume, a pitch, an interval, and other parameters used for sound synthesis with each information label constituting the feature information in advance. The sound conversion model Ma can convert the input feature information into acoustic information corresponding to a time-series change in the feature information (a time-series change in the score associated with each information label). When the feature information is converted into the acoustic information, the sound conversion model M can be compressed in a manner that the reproduction time of the acoustic information is shorter than the time corresponding to the feature information. For example, it is conceivable to convert feature information for one day into acoustic information compressed to several tens of seconds.

In addition, the information processing device 100 can also generate an action trajectory data Tj_β in which the action trajectory of the user Ux is expressed (made visible) by an image using an image conversion model M_{β} that converts the feature information into the image information. The image conversion model M_{β} can convert the input feature information into image information corresponding to a time-series change in the feature information (a time-series change in the score associated with each information label). For example, the image conversion model M_{β} can be converted into image information (moving image) in which a display form such as a length or a color of a display object such as a spectrum visually displaying a score of an information label constituting the feature information changes to a different display form for each image frame in conjunction with a time-series change in the score. Note that the image conversion model Mb is not limited to the example of converting the input feature information into image information in which the display form of the display object such as spectrum changes. For example, the model may be a model that converts image information into image information that changes a display form of an arbitrary target, such as image information in which an expression of a face image of the user Ux changes or image information in which weather of a landscape image changes, which is registered in advance or acquired from the service providing device 10, according to a change in feature information. In addition, when the feature information is converted into the image information, the image conversion model M_{β} can compress the image information in a manner that the reproduction time of the image information is shorter than the time corresponding to the feature information, similarly to the case where the feature information is converted into the acoustic signal by the sound conversion model M_{α}.

In addition, the information processing device 100 may be configured to emphasize a characteristic point in the action trajectory of the user Ux when generating the action trajectory data Tj_α in which the action trajectory of the user Ux is expressed (made audible) by a change in sound and the action trajectory data Tj_β in which the action trajectory of the user Ux is expressed (made visible) by an image. For example, when generating the action trajectory data Tj_α in a predetermined time zone, the information processing device 100 may configure the acoustic information in a manner that the volume of a characteristic point in the action trajectory of the user Ux in the predetermined time zone is reproduced large. In addition, for example, when generating the action trajectory data Tj_β in a predetermined time zone, in a case where the action trajectory of the user Ux in the previous time zone is significantly different from the action trajectory of the user Ux in the current time zone (in a case where the current time zone is more characteristic), the information processing device 100 may configure the image information in a manner that the action trajectory in the current time zone is reproduced in a display form clearly different from the action trajectory in the previous time zone.

Note that, as described above, the information processing device 100 is not limited to the case of generating the action trajectory data Tj_α using the sound conversion model M_{α} using a numerical value associated with the position information, the action information, or the like extracted as the feature information from the action history information of the user Ux as a numerical value column (matrix) indicating the action trajectory of the user Ux. For example, the information processing device 100 may generate a feature vector indicating the feature of the action of the user Ux from the action history information of the user Ux using a numerical value associated with the position information, the action information, or the like extracted as the feature information, generate acoustic information according to the generated feature vector, and use it as the action trajectory data.

Returning to FIG. 1, the information processing device 100 transmits the generated action trajectory data to the terminal device 20x (step S1-6), and provides the user Ux with the action trajectory data as an action log of the user Ux. The user Ux of the terminal device 20x can confirm the life log of the user Ux by reproducing the action trajectory data received from the information processing device 100 in the terminal device 20x.

As described above, the information processing device 100 according to the embodiment generates the action trajectory data expressing the compressed action trajectory in the time axis direction using the feature information extracted from the action history information, and provides the action trajectory data to the user Ux. As a result, the burden on the user Ux required to confirm the life log can be reduced.

2. System Configuration

A configuration example of the information processing system 1 including the information processing device 100 according to the embodiment will be described with reference to FIG. 3. FIG. 3 is a diagram illustrating a configuration example of the information processing system according to the embodiment. Note that FIG. 3 illustrates the configuration of the information processing system 1 according to the embodiment, and is not limited to the form illustrated in FIG. 3, and may be a form including more devices than the example illustrated in FIG. 3.

As illustrated in FIG. 3, an information processing system 1 according to the embodiment includes the service providing device 10, a plurality of terminal devices 20, and the information processing device 100. The service providing device 10, the terminal device 20, and the information processing device 100 are each connected to the network N in a wired or wireless manner. The network N is a communication network such as a local area network (LAN), a wide area network (WAN), a telephone network (a mobile phone network, a fixed telephone network, or the like), a regional Internet protocol (IP) network, or the Internet. The network N may include a wired network or a wireless network. The service providing device 10, the terminal device 20, and the information processing device 100 can communicate with each other through the network N.

Service Providing Device 10

The service providing device 10 is a device that provides various services to a service user through distribution of a web page, and is typically a server device or the like. For example, the service providing device 10 distributes, to the terminal device 20, a web page that is a portal site on which various types of information related to a social network service (SNS), a news site, an auction site, a weather forecast site, a shopping site, a finance (stock price) site, a route search site, a map providing site, a travel site, a restaurant introduction site, a web blog, a schedule management site, or the like are arranged. Note that the service providing device 10 may be a server that distributes, to the terminal device 20, a web page in which various types of information are arranged in a tile shape and information is updated for each tile.

In addition, the service providing device 10 can collect digital data (life log) in which various daily activities of each service user are recorded through provision of various services. For example, the service providing device 10 can collect, as a life log of the user Ux of the terminal device 20, position history information indicating a history of a position where the service user has moved, an image such as a still image or a moving image photographed by the service user, various types of message information written in an e-mail, a short message service, a SNS (posting services, bulletin boards, timelines), or the like, schedule information registered by the service user, or the like. Note that the life log that can be collected by the service providing device 10 is not limited to these, and may include, for example, various types of payment data such as payment of public utility charges such as electricity charges of each service user and payment by a credit card or electronic money, and healthcare data in which daily weight, the number of steps, a movement distance, calorie consumption, or the like of each service user is recorded. In addition, the service providing device 10 may collect data from an external device such as another server device at a predetermined timing.

In addition, the web page distributed by the service providing device 10 includes an acquisition command of content arranged on the web page. For example, a URL or the like of the information processing device 100 may be described as an acquisition command in an HTML file or the like forming a web page. In this case, the terminal device 20 acquires the content from the information processing device 100 by accessing this URL.

Terminal Device 20

The terminal device 20 (for example, terminal devices 20x, 20y, 20z, or the like) is a device used by a service user who uses various services provided from the service providing device 10. The terminal device 20 is typically a smartphone. The terminal device 20 may be an arbitrary information processing device such as various personal computers (PCs) of a desktop type, a notebook type, or a tablet type, a mobile phone, a personal digital assistant (PDA), or a wearable device.

In addition, the terminal device 20 stores a life log recorded in association with use of various services provided from the service providing device 10. For example, the terminal device 20 incorporates a global positioning system (GPS) receiver, measures a current position periodically based on a radio wave received from a GPS satellite, and stores the measured position as position history information together with date and time of measurement. In addition, the terminal device 20 incorporates a digital camera, and stores image data of an image such as a still image or a moving image photographed by the camera in a predetermined file format. The image data may include a photographing date and time, an imaging position, and a tag (character information) in a header or the like. In addition, the terminal device 20 stores messages transmitted and received by a call record, an e-mail, a short message service, or the like, and message information regarding various messages written in an SNS or the like. In addition, the terminal device 20 can store various types of payment data such as payment of public utility and payment by a credit card or electronic money, and healthcare data in which daily weight, the number of steps, a movement distance, calorie consumption, or the like of each service user is recorded.

In addition, the terminal device 20 may transmit various life logs such as the position history information, the image data, the call record, and the message information to the service providing device 10 along with the use of various services provided from the service providing device 10. The terminal device 20 may be periodically transmitted to the service providing device 10 without using the service.

In addition, the terminal device 20 can receive the action trajectory data indicating the action trajectory from the information processing device 100 by transmitting the acquisition request of the life log to the information processing device 100. The terminal device 20 can reproduce the action trajectory data in a manner that a user U who is the owner of the terminal can recognize the action trajectory data, for example. For example, in a case where the action trajectory data includes acoustic information, the terminal device 20 reproduces the action trajectory data into a state where the user U can listen to the action trajectory data by the acoustic reproduction function. In addition, in a case where the action trajectory data includes image information, the terminal device 20 reproduces the action trajectory data to a state in which the user U can visually recognize the action trajectory data by the image reproduction function.

The information processing device 100 is a device that generates and provides action trajectory data expressing a compressed action trajectory of the user U as a life log of the user U of the terminal device 20, and is typically a server device.

3. Configuration of Information Processing Device

A configuration of the information processing device 100 according to the embodiment will be described with reference to FIG. 4. FIG. 4 is a diagram illustrating a configuration example of the information processing device according to the embodiment. The information processing device 100 illustrated in FIG. 4 is typically a server device.

As illustrated in FIG. 4, the information processing device 100 includes a communication unit 110, a storage unit 120, and a control unit 130. Note that FIG. 4 illustrates a configuration example of the information processing device 100, and is not limited to the form illustrated in FIG. 4, and may be a form including a functional unit other than those illustrated in FIG. 4.

Communication Unit 110

The communication unit 110 is connected to the network N in a wired or wireless manner, for example, and transmits and receives information to and from other devices via the network N. The communication unit 110 is realized by, for example, a network interface card (NIC), an antenna, or the like. The network N is a communication network such as a local area network (LAN), a wide area network (WAN), a telephone network (a mobile phone network, a fixed telephone network, or the like), a regional Internet protocol (IP) network, or the Internet. The network N may include a wired network or a wireless network.

Storage Unit 120

The storage unit 120 is realized by, for example, a semiconductor memory element such as a random access memory (RAM) or a flash memory, or a storage device such as a hard disk or an optical disk. As illustrated in FIG. 4, the storage unit 120 includes a feature information storage unit 121, a model storage unit 122, and a user information storage unit 123.

Feature Information Storage Unit 121

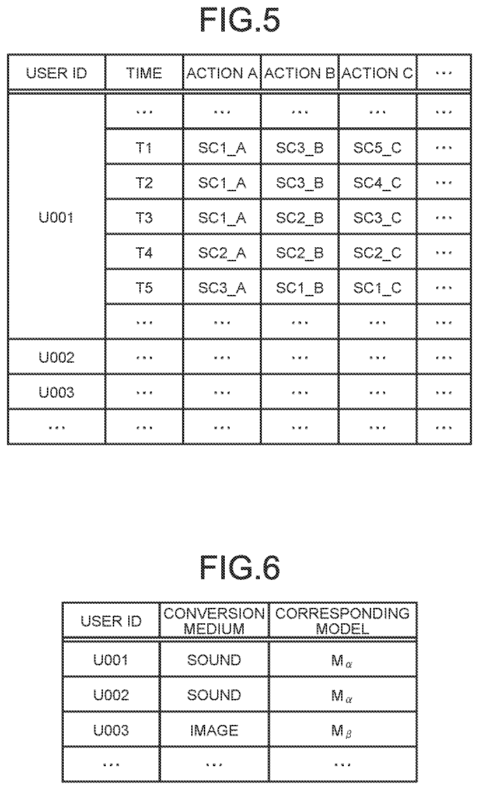

The feature information storage unit 121 stores feature information extracted from the action history information of each user of each terminal device 20. FIG. 5 is a diagram illustrating an example of action history information according to the embodiment. Note that FIG. 5 illustrates an outline of the feature information stored in the feature information storage unit 121, and may not be configured in the form illustrated in FIG. 5.

As illustrated in FIG. 5, the feature information stored in the feature information storage unit 121 includes an item of “user ID”, an item of “time”, an item of “action A”, an item of “action B”, an item of “action C”, or the like. In the feature information, these items are associated with each other.

In the item of “user ID”, identification information for identifying each provision destination user serving as a provision destination of the action trajectory data is stored. As the identification information, identification information individually allocated to each user who uses various services provided by the service providing device 10 may be used as it is.

In the item of “time”, information indicating the time when the action history information of each provision destination user is recorded is stored. The information indicating the time can be extracted from the action history information received from the service providing device 10.

Numerical values (scores) associated with the action of each provision destination user are stored in items such as “action A” to “action C”. In other words, numerical values for specifying the time-series change in the action of the provision destination user are stored in the items such as “action A” to “action C”.

The operator of the information processing device 100 can arbitrarily select each action constituting the life log of each provision destination user and a numerical value associated with each action from the action history information of each user. Each action constituting the life log of each provision destination user can be selected from basic information of each provision destination user such as an activity time and a sleep time, a use history of various services corresponding to each provision destination user, or the like.

For example, [sleep] may be selected as the “action A”, and [sleep time] may be selected as a numerical value associated with the “action A”. As the sleep time in this case, the sleep time included in the healthcare data of the action history information may be used. As a result, the action trajectory based on the relationship between sleep and sleep time is derived. In addition, [movement] may be selected as the “action B”, and [movement distance] may be selected as a numerical value associated with the “action B”. As a result, the action trajectory based on the relationship between the movement and the movement distance is derived. In addition, as the movement distance in this case, a numerical value of the distance calculated based on the history of the position included in the action history information may be used, or information of the walking distance included in the healthcare data of the action history information may be used. In addition, [shopping] may be selected as the “action C”, and [payment amount] may be selected as a numerical value associated with the “action C”. As a result, the action trajectory based on the relationship between shopping and the payment amount is derived. As the payment amount in this case, information on the payment amount at the shopping site or the payment amount by a credit card or electronic money may be used.

In addition, the operator of the information processing device 100 may associate, as the numerical value associated with the action, a numerical value that indirectly characterizes the contents of the action, instead of a numerical value that directly characterizes the contents of the action. For example, it is conceivable to select [posting to SNS] as the “action A” and select [the number of views of posts (or the number of reactions to posts)] as a numerical value associated with the “action A”. As a result, the action trajectory based on the relationship between posting to SNS and the number of views of posts (or the number of reactions to posts) is derived. In addition, it is conceivable to select [exercise] as the “action A” and select [temperature on the day] as a numerical value associated with the “action A”. As a result, the action trajectory based on the relationship between the exercise and the temperature on the day is derived.

Each action constituting the life log of each provision destination user is not limited to the above-described action, and a record of each user such as search on a search site, writing of a schedule to a schedule management site, or photographing of an image can be arbitrarily selected.

Model Storage Unit 122

The model storage unit 122 stores information regarding a conversion model that converts the feature information extracted from the action history information into action trajectory data. For example, the information regarding the conversion model stored in the model storage unit 122 is parameter information associated in advance with each information label constituting the feature information.

For example, the model storage unit 122 can store information regarding the sound conversion model Ma that converts the input feature information into the acoustic information corresponding to the time-series change in the feature information (the time-series change in the score associated with each information label). The sound conversion model M_{α} can be configured by associating a volume, a pitch, an interval, and other parameters used for sound synthesis with each information label constituting the feature information in advance by a method such as parameter mapping. For example, the sound conversion model M_{α} can convert the feature information into the acoustic information by mapping a sound synthesized with a volume or a pitch corresponding to the variation of the score associated with the information label. When the feature information is converted into the acoustic information, the sound conversion model M_{α} can be compressed in a manner that the reproduction time of the acoustic information is shorter than the time corresponding to the feature information. For example, it is conceivable to convert feature information for one day (for example, 16 hours) into acoustic information compressed to several tens of seconds.

In addition, for example, the model storage unit 122 can store information regarding the image conversion model M that converts the input feature information into the image information corresponding to the time-series change in the feature information. For example, the image conversion model M_{β} can be converted into image information (moving image) in which a display form such as a length or a color of a spectrum visually displaying a score of an information label constituting the feature information changes to a different display form for each image frame in conjunction with a time-series change in the score. Note that the image conversion model M_{β} is not limited to the example of converting the input feature information into image information in which the display form of the display object such as spectrum changes. For example, the model may be a model that converts image information into image information that changes a display form of an arbitrary target, such as image information in which an expression of a face image of the user U changes or image information in which weather of a landscape image changes, which is registered in advance or acquired from the service providing device 10, according to a change in feature information. In addition, when the feature information is converted into the image information, the image conversion model M_{β} can be compressed in a manner that the reproduction time of the image information is shorter than the time corresponding to the feature information, similarly to the sound conversion model Ma.

User Information Storage Unit 123

The user information storage unit 123 stores user information regarding a provision destination user to be a provision destination of the action trajectory data. FIG. 6 is a diagram illustrating an example of user information according to the embodiment. Note that FIG. 6 illustrates an outline of the user information stored in the user information storage unit 123, and may not be configured in the form illustrated in FIG. 6.

As illustrated in FIG. 6, the user information stored in the user information storage unit 123 includes an item of “user ID”, an item of “conversion medium”, and an item of “corresponding model”. In the user information, these items are associated with each other.

In the item of “user ID”, identification information for identifying the provision destination user serving as a provision destination of the action trajectory data is stored. As the identification information, identification information individually allocated to each user who uses various services provided by the service providing device 10 may be used as it is.

In the item of “conversion medium”, information of the conversion medium of the life log desired by the provision destination user who is the provision destination of the action trajectory data is stored. In the item of “corresponding model”, identification information for identifying the conversion model corresponding to the conversion medium desired by the provision destination user is stored.

According to the example illustrated in FIG. 6, it is illustrated that the provision destination user of the user ID: [U001] desires [sound] as the conversion medium of the life log, and [sound conversion model M_{α}] is associated as the conversion model corresponding to the conversion medium.

Note that, as the user information illustrated in FIG. 6, information on a distribution frequency at which the provision destination user desires to distribute the life log, information on a distribution desired time, or the like may be stored. In this case, the control unit 130 to be described later can execute processing for acquiring the action history information of the provision destination user from the service providing device 10 based on the distribution desired time and the distribution frequency.

For example, when the distribution frequency is [every day] and the distribution desired time is “23:00”, the control unit 130 to be described later transmits an action history information transmission request for requesting transmission of action history information of the provision destination user to the service providing device 10 at 23:00 every day. In addition, for example, when the distribution frequency is [every Sunday] and the distribution desired time is “23:00”, the control unit 130 to be described later transmits an action history information acquisition request for requesting acquisition of action history information of the provision destination user to the service providing device 10 at 23:00 every Sunday. In addition, the control unit 130 to be described later may automatically set the response time of the action history information requested to be transmitted to the service providing device 10 according to the distribution frequency and the distribution desired time. As described above, for example, in a case where the distribution frequency is [every day] and the distribution desired time is [23:00], the control unit 130 may automatically set 16 hours before the distribution desired time as the start time and request transmission of the action history information for every hour from 7:00 AM to 23:00 PM. In addition, for example, in a case where the distribution frequency is [every Sunday] and the distribution desired time is [23:00], transmission of the action history information for each hour from 7:00 AM to 23:00 PM on each day from Monday to Sunday may be requested.

Control Unit 130

Returning to FIG. 4, the control unit 130 is a controller that controls the information processing device 100. The control unit 130 is realized by executing various programs (for example, an information processing program) stored in a storage device inside the information processing device 100 using a RAM as a work area by a central processing unit (CPU), a micro processing unit (MPU), or the like. In addition, the control unit 130 may be realized by, for example, an integrated circuit such as an application specific integrated circuit (ASIC) or a field programmable gate array (FPGA).

As illustrated in FIG. 4, the control unit 130 includes an extraction unit 131, a generation unit 132, and a provision unit 133. The control unit 130 realizes or executes a function and an action of information processing described below by these units. Note that the internal configuration of the control unit 130 is not limited to the configuration illustrated in FIG. 4, and may be another configuration as long as information processing to be described later is performed. In addition, the connection relationship of each unit included in the control unit 130 is not limited to the connection relationship illustrated in FIG. 4, and may be another connection relationship. Note that, in addition to the extraction unit 131, the control unit 130 may include a reception unit for acquiring various types of information such as the action history information corresponding to the provision destination user from the cooperating service providing device 10 through the network N.

Extraction Unit 131

The extraction unit 131 extracts feature information for specifying an action of the provision destination user from the action history information of the provision destination user. Specifically, when receiving the life log confirmation request from the terminal device 20, the extraction unit 131 transmits an action history information acquisition request regarding the provision destination user who is a transmission source of the life log confirmation request to the service providing device 10. For example, the extraction unit 131 can request acquisition of action history information recorded within a predetermined period such as several hours, one day, or one week for the partner user. The corresponding period of the action history information requested to be acquired by the service providing device 10 may be set by the partner user when the life log confirmation request is transmitted, or may be set in advance as a part of the user information stored in the user information storage unit 123. Note that the extraction unit 131 is not limited to the case of transmitting the action history information acquisition request to the service providing device 10 in response to the reception of the life log confirmation request. For example, the extraction unit 131 may transmit the action history information acquisition request at a timing set in advance for each partner user, such as 22:00 or 23:00 every day. In this case, the corresponding period of the action history information requested to be acquired by the service providing device 10 may also be set in advance.

In addition, when receiving the action history information of the provision destination user from the service providing device 10, the extraction unit 131 extracts feature information for specifying an action of the provision destination user from the received action history information. For example, the extraction unit 131 can extract position information, action information, or the like of the user Ux recorded within a certain period from the action history information as the feature information described above. The action information can be extracted from basic information of each provision destination user such as an activity time and a sleep time, a use history of various services corresponding to each provision destination user, or the like. The extraction unit 131 stores the extracted feature information in the feature information storage unit 121.

Generation Unit 132

The generation unit 132 generates action trajectory data in which the action trajectory of the provision destination user within a predetermined period is compressed and expressed using the feature information extracted by the extraction unit 131. For example, the generation unit 132 generates action trajectory data that abstractly expresses the action trajectory of the provision destination user within a predetermined period. Specifically, the generation unit 132 specifies a conversion model associated with the user ID based on the user ID of the provision destination user. In a case where the specified conversion model is the sound conversion model M_{α} that converts the feature information into the acoustic information, the generation unit 132 uses the specified sound conversion model M_{α} to generate action trajectory data in which the action trajectory of the provision destination user is expressed by a change in sound of a predetermined length.

In addition, when the feature information is converted into the acoustic information, the generation unit 132 can adjust and compress the length of the acoustic information in a manner that the reproduction time of the acoustic information is shorter than the time corresponding to the feature information. For example, it is assumed that the generation unit 132 converts feature information for 16 hours extracted every one hour into acoustic information having a reproduction time of 48 seconds. In this case, the feature information is converted into the acoustic information by performing even mapping in a manner that the length of the acoustic information corresponding to the time-series change of the feature information corresponding to each time per hour is three seconds.

In addition, in a case where the specified conversion model is the image conversion model M_{β} that converts the feature information into the image information, the generation unit 132 generates action trajectory data in which the action trajectory of the provision destination user is expressed by an image. Note that the generation unit 132 can compress the image information in a manner that the reproduction time of the image information is shorter than the time corresponding to the feature information, similarly to the case of converting the feature information into the acoustic signal.

Provision Unit 133

The provision unit 133 transmits the action trajectory data generated by the generation unit 132 to the terminal device 20 of the provision destination user to provide the action trajectory data to the provision destination user.

4. Processing Procedure

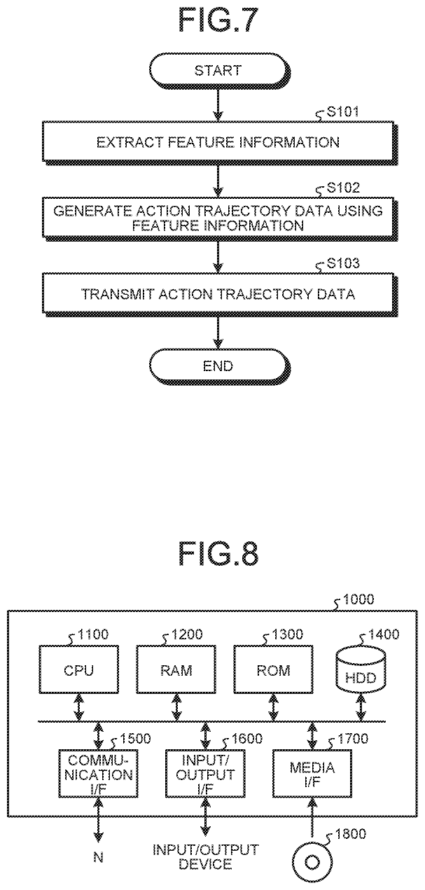

Hereinafter, a procedure of processing by the information processing device 100 according to the embodiment will be described with reference to FIG. 7.

FIG. 7 is a flowchart illustrating an example of a processing procedure by the information processing device according to the embodiment. The processing procedure illustrated in FIG. 7 is executed by the control unit 130 of the information processing device 100. The processing procedure illustrated in FIG. 7 is repeatedly executed while the information processing device 100 is in operation.

As illustrated in FIG. 7, the extraction unit 131 extracts feature information for specifying an action of the provision destination user from the action history information received from the service providing device 10 (step S101). For example, the extraction unit 131 can extract position information, action information, or the like of the user Ux recorded within a certain period from the action history information as the feature information described above.

In addition, the generation unit 132 generates action trajectory data in which the action trajectory of the provision destination user within a predetermined period is compressed and expressed using the feature information extracted by the extraction unit 131 (S102). For example, the generation unit 132 can generate action trajectory data that can be recognized by the provision destination user audibly or visually.

In addition, the provision unit 133 transmits the action trajectory data generated by the generation unit 132 to the terminal device 20 of the provision destination user (step S103) to provide the action trajectory data to the provision destination user.

5. Modification

The information processing device 100 according to the above-described embodiment may be implemented in various different modes other than the above-described embodiment. Therefore, a modification of the embodiment according to the information processing device 100 described above will be described below.

5-1. Modification of Conversion Model

In the above-described embodiment, the information processing device 100 may correct the conversion model based on the feedback from the provision destination user who has provided the action trajectory data. For example, the generation unit 132 transmits a questionnaire for collecting impressions on the action trajectory data from the provision destination user to whom the action trajectory data is provided each time the action trajectory data is provided. The generation unit 132 aggregates the answers to the questionnaire from the provision destination user, examines the contents of the aggregated answers, and corrects the conversion model. For example, as a modification example of the sound conversion model M_{α} for converting feature information into an acoustic signal, it is conceivable to adjust a parameter in a manner that a small volume is mapped to a portion where a large volume is mapped, or adjust a parameter in a manner that a high sound is mapped to a portion where a low sound is mapped.

5-2. About Conversion Medium of Life Log

In the above-described embodiment, an example has been described in which the information processing device 100 generates action trajectory data in which the action trajectory of the provision destination user is abstractly expressed by a sound or an image, but the present invention is not limited to this example. For example, the information processing device 100 may generate action trajectory data in which the action trajectory of the provision destination user is abstractly expressed in a form that can be recognized by a sense of touch or a sense of smell. As the action trajectory data corresponding to the sense of touch, expression using a vibration pattern for driving a vibration device as a conversion medium of a life log, the feedback of a sense of force by a tactile sense presentation technology (haptics), or the like can be considered. For example, it is conceivable that the information processing device 100 transmits a control signal for controlling the vibration device included in the terminal device 20 to the terminal device 20 to provide the action trajectory data corresponding to the sense of touch to the provision destination user. In addition, as the action leaving data corresponding to the sense of smell, diffusion of a scent by an aroma diffuser or the like can be used. For example, it is conceivable that the information processing device 100 transmits a control signal for controlling the operation of the aroma diffuser wirelessly connected to the terminal device 20 via the terminal device 20 to provide the action trajectory data corresponding to the sense of touch to the provision destination user.

5-3. Provision of Action History Using Action Trajectory Data

In the above-described embodiment, the information processing device 100 may further provide the action history information associated with the designated point in the action trajectory data designated by the provision destination user to the provision destination user of the action trajectory data. For example, the provision unit 133 of the information processing device 100 can receive the designated point according to the reproduction time of the acoustic information or the image information constituting the action trajectory data. Then, the provision unit 133 acquires the action history information corresponding to the designated point from the service providing device 10, and provides the acquired action history information to the provision destination user. In addition, the information processing device 100 may acquire action history information associated with action trajectory data similar to the action trajectory data and provide the action history information to the provision destination user. Note that the information processing device 100 may accept registration of the action trajectory data in a manner that the provision destination user can search and acquire the action trajectory data afterwards.

6. Hardware Configuration

The information processing device 100 according to the embodiment and the modifications is realized by a computer 1000 having a configuration as illustrated in FIG. 8, for example. FIG. 8 is a hardware configuration diagram illustrating an example of a computer that realizes functions of the information processing device according to the embodiment and the modifications.

The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates based on a program stored in the ROM 1300 or the HDD 1400, and controls each unit. The ROM 1300 stores a boot program executed by the CPU 1100 when the computer 1000 is activated, a program depending on hardware of the computer 1000, or the like.

The HDD 1400 stores a program executed by the CPU 1100, data used by the program, or the like. The communication interface 1500 receives data from other devices via the network (communication network) N, sends the data to the CPU 1100, and transmits data generated by the CPU 1100 to other devices via the network (communication network) N.

The CPU 1100 controls output devices such as a display and a printer, and input devices such as a keyboard and a mouse via the input/output interface 1600. The CPU 1100 acquires data from the input device via the input/output interface 1600. In addition, the CPU 1100 outputs the generated data to the output device via the input/output interface 1600.

The media interface 1700 reads a program or data stored in a recording medium 1800 and provides the program or data to the CPU 1100 via the RAM 1200. The CPU 1100 loads the program from the recording medium 1800 onto the RAM 1200 via the media interface 1700, and executes the loaded program. The recording medium 1800 is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing device 100 according to the embodiment, the CPU 1100 of the computer 1000 realizes the function of the control unit 130 by executing a program loaded on the RAM 1200. In addition, the HDD 1400 stores data in the storage unit 120. The CPU 1100 of the computer 1000 reads and executes these programs from the recording medium 1800, but as another example, these programs may be acquired from another device via the network (communication network) N.

7. Others

Among the pieces of processing described in the above-described embodiments and modifications, all or a part of the pieces of processing described as being automatically performed can be manually performed, or all or a part of the pieces of processing described as being manually performed can be automatically performed by a known method. In addition, the processing procedure, specific name, and information including various data and parameters illustrated in the above document and the drawings can be arbitrarily changed unless otherwise specified.

In the above-described embodiment and modified example, in order to realize the information processing method by the information processing device 100 (see FIG. 7), the processing function corresponding to each unit (the extraction unit 131, the generation unit 132, and the provision unit 133) of the control unit 130 included in the information processing device 100 may be realized as an add-on to the information processing program installed in advance in the information processing device 100, or may be realized by flexibly describing the processing function as a dedicated information processing program using a lightweight programming language or the like.

In addition, each component of each device illustrated in the drawings is functionally conceptual, and is not necessarily physically configured as illustrated in the drawings. That is, a specific form of distribution and integration of each device is not limited to the illustrated form, and all or a part of it can be functionally or physically distributed and integrated in an arbitrary unit according to various loads, usage conditions, or the like.

In addition, the above-described embodiments and modifications can be appropriately combined within a range that does not contradict processing contents.

8. Effects

The information processing device 100 according to the above-described embodiment or modification includes the extraction unit 131, the generation unit 132, and the provision unit 133. The extraction unit 131 extracts feature information for specifying an action of the user from the action history information of the user. The generation unit 132 generates action trajectory data in which the action trajectory of the user within a predetermined period is compressed and expressed in the time axis direction using the feature information extracted by the extraction unit 131. The provision unit 133 provides the user with the action trajectory data generated by the generation unit 132.

As described above, the information processing device 100 according to the embodiment or the modification can reduce the burden on the user required to confirm the life log.

In addition, in the information processing device 100 according to the embodiment or the modification, the generation unit 132 generates action trajectory data that can be recognized by the user audibly or visually. As a result, the information processing device 100 can provide the user with an abstract life log that can be intuitively recognized in a short time.

In addition, in the information processing device 100 according to the embodiment or the modification, the generation unit 132 generates the action trajectory data in which the action trajectory of the user is expressed by sound, using the conversion model that converts the feature information into the acoustic information. As a result, the information processing device 100 can provide the user with an abstract life log that can be easily confirmed only by hearing.

In addition, in the information processing device 100 according to the embodiment or the modification, the generation unit 132 corrects the conversion model based on the feedback from the user. As a result, the information processing device 100 can reduce the difference in feeling from the user with respect to the life log expressed by sound.

Although the embodiments of the present application have been described in detail with reference to some drawings, these are merely examples, and the present invention can be implemented in other forms subjected to various modifications and improvements based on the knowledge of those skilled in the art, including the aspects described in the disclosure of the invention.

In addition, the “part (section, module, unit)” described above can be read as “means”, “circuit”, or the like. For example, the generation unit can be read as a generation means or a generation circuit.

According to one aspect of the embodiment, it is possible to reduce the burden on the user required to confirm the life log.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
an extraction unit that extracts, from action history information of a user, feature information for specifying an action of the user;
a generation unit that generates action trajectory data expressing a compressed action trajectory of the user within a predetermined period in a time axis direction by using the feature information extracted by the extraction unit; and
a provision unit that provides the user with the action trajectory data generated by the generation unit.

2. The information processing device according to claim 1, wherein
the generation unit
generates the action trajectory data in which an action trajectory of the user is expressed by a change in sound of a predetermined length using a conversion model that converts the feature information into acoustic information.

3. The information processing device according to claim 2, wherein
the generation unit
corrects the conversion model based on feedback from the user.

4. The information processing device according to claim 1, wherein
the provision unit
provides the user with the action history information associated with a designated point designated by the user in the action trajectory data.

5. An information processing method executed by a computer, the method comprising:
an extraction step that extracts, from action history information of a user, feature information for specifying an action of the user;
a generation step that generates action trajectory data expressing a compressed action trajectory of the user within a predetermined period in a time axis direction by using the feature information extracted by the extraction step; and
a provision step that provides the user with the action trajectory data generated by the generation step.

6. A non-transitory computer-readable storage medium storing an information processing program for causing the computer to execute:
an extraction procedure that extracts, from action history information of a user, feature information for specifying an action of the user;
a generation procedure that generates action trajectory data expressing a compressed action trajectory of the user within a predetermined period in a time axis direction by using the feature information extracted by the extraction procedure; and
a provision procedure that provides the user with the action trajectory data generated by the generation procedure.
